(19) United States
(12) Patent Application Publication
(10) Pub. No.: US 2018/0222135 A1
(43) Pub. Date: Aug. 9, 2018

(54) ROTOR BLADE ELEMENT WITH ANTI-ICING SURFACE FOR WIND TURBINE ROTOR BLADES

(71) Applicant: BASF SE, Ludwigshafen (DE)

(72) Inventors: Sulivan DIAS BORGES VIANNA, Altrip (DE); Zeljko TOMOVIC, Lemförde (DE)

(21) Appl. No.: 15/505,950

(22) PCT Filed: Aug. 7, 2015
(86) PCT No.: PCT/EP2015/068289

§ 371 Date: Feb. 23, 2017

(30) Foreign Application Priority Data
Aug. 27, 2014 (EP) 14182469.8
Dec. 19, 2014 (DE) 102014226609.2

(51) Int. Cl. B29C 70/88; F03D 80/40; B29C 70/44; B32B 27/40

(52) U.S. Cl. CPC B29C 70/885; F03D 80/40; B29K 2075/00; B32B 27/40; B29C 70/443

(57) ABSTRACT

A rotor blade element with a heatable foil (2, 3, 6) comprising a thermoplastic elastomer (TPE) and electric conductive elements (4), a wind power plant comprising this rotor blade element and a process for producing the rotor blade element comprising the steps:
I) introducing a heatable foil (2, 3, 6), comprising a thermoplastic elastomer (TPE) and electric conductive elements (4) onto a mold;
II) introducing a reinforcing material and prefabricated elements and/or additional parts onto the mold;
III) vacuum-bagging of the complete setup
IV) infusing curable resin; and
V) curing the resin.

This invention concerns a rotor blade element comprising a heatable thermoplastic foil, a wind power plant comprising this rotor blade elements and a process for producing the rotor blade element.

Rotor blades for wind power plants are mostly built of fiber reinforced plastics (composites). As matrix material, often thermosets such as polyesters, vinylesters, polyurethanes and particularly epoxy resins are used. Carbon fibers and particularly glass fibers are used as reinforcing materials. The main manufacturing route for rotor blades is vacuum-assisted resin transfer molding (also referred to as vacuum infusion) and, to a minor extent, other technologies including pre-preg, filament winding, pultrusion and fiber place. For the outer surface of the blade, the so-called shell section, mainly vacuum infusion is used.

Primer and coating systems have been developed to provide high quality surfaces in terms of roughness, gloss, and applicability, but also to protect the composite structure against strong environmental impacts, such as sand and rain erosion or UV irradiation. Coatings are mainly applied as viscous, reactive liquid formulations, which subsequently react to generate the final product characteristics.

WO 2010/121927 discloses a rotor blade or rotor blade element for a wind power installation having a surface foil and a curable resin, wherein the surface foil has been reacted with the resin to form an integral portion of the rotor blade or rotor blade element. This process reduces time for manufacturing of rotor blades or rotor blade components by reducing the number of process steps and materials needed, such as release agents.

EP 2551 314 A1 discloses a multilayer protective tape with a profiled surface for rotor blades of wind turbine generators. The top layer of the protective tape is preferably made from thermoplastic elastomeric polyurethane (TPU) and the bottom layer is made from a pressure sensitive adhesive. The stability of the adhesive layer may not be sufficient after some time due to sand and rain erosion.

A great amount of wind power plants are located in cold regions, where icing at low temperatures and high humidity is a problem. Icing can cause vibrations and damage to the wind power plant, reduces aerodynamics and technical availability. Energy production is therefore reduced by icing events. Icing can be avoided or reduced by active and passive anti/de-icing systems. Conductive substrates for deicing by heating up a layer or coating on the surface by means of electrical resistance (i.e. WO 01/08973), electromagnetic induction or IR/microwave radiation (WO 2013/172762 or hot-gas heating (i.e. DE 10 2010 051 293 A1) are known. Application of IR/microwave is technically difficult and could lead to damage of other unwanted regions in case interactions with those radiations occur. Hot air heating is not highly efficient, specially for long blades. Apart from that, blade manufacturing suffers from considerable change in number of steps and materials used. It is also important to consider that bulk heating requires high energy and decreases fatigue life of the blades.

EP 0 646 524 A1 discloses an improved ice protection apparatus including a top polyurethane layer, an active layer and a base layer cured together into a unitary matrix. The active layer may be either a thermal ice protector, a pneumatic ice protector or an electro magnetic protection apparatus.

In order to avoid heating the bulk of the blade during deicing and decrease the number of steps during blade manufacture, a heatable surface, or more specifically, a heatable coating or surface protection is the route to solution.

A heatable surface could be generated by, e.g. producing an electrically conductive coating by introducing electric conductive elements such as graphite, metal dispersions, graphene, carbon nano-tubes (WO 2012/046031), carbon black, metal particles, etc, to classical blade coatings, at high enough concentrations, i.e. higher than a certain percolation length, allowing an efficient heat generation by passing an electric current throughout the material. The physical principle behind it is the so-called Joule effect. However, the viscosities of such coatings increase dramatically at such dispersion concentrations altering the rheological characteristics of such coatings, so that its application to the surface including proper film formation is no longer possible.

WO 2005/082988 and DE 10 2012 203 994 discloses anti-static or conductive polyurethane comprising carbon nanotubes and ionic liquid and a concentrate comprising the thermoplastic polyurethane including carbon nanotubes (5-30 weight percent) and ionic liquid (5-20 weight percent). The anti-static or conductive polyurethane can be used for the manufacture of heatable parts.

US 2011/0281071 relates to a method for introducing electrically conductive carbon particles, in particular carbon nanotubes into a surface layer comprising polyurethane, wherein a solution of non-aggregated carbon particles having a mean particle diameter of from 0.3 nm to 3000 nm acts in a solvent upon a surface layer comprising polyurethane.

European Patent Application 13172116.9 discloses the use of conductive thermoplastic polyurethane compositions with carbon based conductive additives for electrically heatable moldings for automotive applications such as window wipers.

Hydrophobic coatings or foils show in general a better passive anti-icing effect as hydrophilic surfaces. WO 2011/020876 discloses a wind turbine component having an exposed surface made of a hydrophobic material and having a surface texture providing a Water Contact Angle unwanted regions in case interactions with those radiations occur. Hot air heating is not highly efficient, specially for long blades. Apart from that, blade manufacturing suffers from considerable change in number of steps and materials used. It is also important to consider that bulk heating requires high energy and decreases fatigue life of the blades.

EP 0 646 524 A1 discloses an improved ice protection apparatus including a top polyurethane layer, an active layer and a base layer cured together into a unitary matrix. The active layer may be either a thermal ice protector, a pneumatic ice protector or an electro magnetic protection apparatus.

In order to avoid heating the bulk of the blade during deicing and decrease the number of steps during blade manufacture, a heatable surface, or more specifically, a heatable coating or surface protection is the route to solution.

A heatable surface could be generated by, e.g. producing an electrically conductive coating by introducing electric conductive elements such as graphite, metal dispersions, graphene, carbon nano-tubes (WO 2012/046031), carbon black, metal particles, etc, to classical blade coatings, at high enough concentrations, i.e. higher than a certain percolation length, allowing an efficient heat generation by passing an electric current throughout the material. The physical principle behind it is the so-called Joule effect. However, the viscosities of such coatings increase dramatically at such dispersion concentrations altering the rheological characteristics of such coatings, so that its application to the surface including proper film formation is no longer possible.

WO 2005/082988 and DE 10 2012 203 994 discloses anti-static or conductive polyurethane comprising carbon nanotubes and ionic liquid and a concentrate comprising the thermoplastic polyurethane including carbon nanotubes (5-30 weight percent) and ionic liquid (5-20 weight percent). The anti-static or conductive polyurethane can be used for the manufacture of heatable parts.

US 2011/028107 relates to a method for introducing electrically conductive carbon particles, in particular carbon nanotubes into a surface layer comprising polyurethane, wherein a solution of non-aggregated carbon particles having a mean particle diameter of from 0.3 nm to 3000 nm acts in a solvent upon a surface layer comprising polyurethane.

European Patent Application 13172116.9 discloses the use of conductive thermoplastic polyurethane compositions with carbon based conductive additives for electrically heatable moldings for automotive applications such as window wipers.

Hydrophobic coatings or foils show in general a better passive anti-icing effect as hydrophilic surfaces. WO 2011/020876 discloses a wind turbine component having an exposed surface made of a hydrophobic material and having a surface texture providing a Water Contact Angle (CA) of at least 150°. Due to the hydrophobic material, the component becomes less vulnerable to ice formation. Examples of hydrophobic materials fluroPU and PU and additional PTFE are mentioned, which could be applied to the wind turbine component by spraying.

The problem addressed by the present invention was therefore that of providing an ice resistant rotor blade or rotor blade element without ice formation as well as an economic process for producing or repairing such rotor blades or rotor blade elements.

The invention provides a rotor blade element comprising a heatable thermoplastic foil comprising a thermoplastic elastomer (TPE) and electric conductive elements, a wind power plant comprising this rotor blade element(s) and a process for producing the rotor blade element.

Thermoplastic elastomers on basis of polyolefins (TPO), thermoplastic polyurethanes (TPU), thermoplastic copolyester (TPC), thermoplastic polyamides (TPA) or thermoplastic styrene block copolymers (TPS) may be used as thermoplastic elastomers. The elongation at break according to DIN EN ISO 527-2 of the thermoplastic elastomers is generally higher than 100%, preferably higher than 200%. The thermoplastic elastomers may be amorphous or partially crystalline.

The heatable thermoplastic foil preferably consists of a foil comprising at least one electrically heatable layer, namely: monolayer. Most preferably, multi-layer system composed by at least 2 layers are possible: one top layer (TL) made from thermoplastic polyurethane (TPU) and a bottom layer (BL) which is an electrically heatable layer. The top layer (-rL) functions as protective layer of the rotor blade element. The bottom layer (BL) preferably is also made from thermoplastic polyurethane (TPU).

The heatable foil is preferably made of a thermoplastic elastomer, even more preferably of thermoplastic polyurethane. This invention also discloses different configurations of the heatable foil and combinations with other materials: (a) direct combination with additional functional polymeric layers such as protective top-layers, particularly prepared via co-extrusion (b) post-coating with other layer, particularly top-coatings and putties (c) integrating function of the top coating to fulfill required performance (color, UV protection, erosion resistance, etc), (d) transparent setups containing non-densely packed heating elements (transparency is often required in order to enable optical analysis for quality control of the infused composite part).

As described above, foils can be integrated as monolayers, coated with additional layers with standard techniques for viscous, reactive coatings, or multilayers integrating different functions can directly be applied.

Preferably the monolayer has a thickness in the range from 10 to 2000 μm, more preferably in the range from 50-1000 μm, most preferable 50-500 μm.

In case of multilayer foils, preferably foils consisting at least of two layers, one top layer (TL) made from thermoplastic elastomer and a bottom layer (BL) which is an electrically heatable conductive layer. The top layer (TL) functions as a protective layer of the rotor blade element. In addition, further intermediate layers may be integrated to fulfill additional functions and to enhance compatibility between layers. In general, thermoplastic elastorners include but are not limited to thermoplastic polyurethanes, thermoplastic polyester elastomers, thermoplastic olefin elastomer, thermoplastic elastomers formed by styrenic copolymers, etc. However, the bottom layer (BL) and top layer are preferably made from thermoplastic polyurethane (TPU).

Preferably the multilayer foil has a thickness in the range from 10 to 2000 μm, more preferably in the range from 50-1000 μm, most preferable 50-500 μm.

Preferably the mono- or multilayer foil is directly fixed onto the rotor blade element structure during the molding process, i.e., vacuum infusion or pre-preg molding, and forms an integral part of the rotor blade element. No extra adhesive layer is present between the foil and composite material of the rotor blade. Adhesion of the foil to the composite takes place during the hardening of the resin on the foil surface, wherein the bottom layer (BL) of multilayer foil is in direct contact with the composite part (epoxy resin, UPE, PUR, etc).

The mono- or multilayer foil preferably has a length (I), a width (w), and a thickness (T). The length of the foil is its longest dimension, followed by its width. Typically, in the blade contour, the foil has width of at least 0.1 m, more preferable 0.2-25 m, more preferable 0.3-12 m, even more preferable 0.5-7 m, and length of at least 1 m, more preferable 1.5-150 m, even more preferable 3-100 m, the most preferable 5-90 m. The multilayer foil has preferably a top layer (TL) and a bottom layer (BL), wherein the top layer (TL) has a continuous surface. The thickness of the top layer (TL) is preferably greater than 10 μm, in the range of 20-2000 μm, preferable 30-1000 μm, more preferable 50-600 μm, even more preferable 100-300 μm, the most preferable 150-200 μm.

The mono- or multilayer foil has surface of at least 0.1 m², preferable 0.5-3500 m², more preferable 1-2000 m², even more preferable 3-1500 m², the most preferable 5-700 m². The roughness of the outer surface of the thermoplastic polyurethane surface should be smaller than 12 μm, preferable less than 8 μm, more preferable less than 6 μm, even more preferable less than 4 μm, measured for example according to DIN EN ISO 4287 and 4288. The color of typical rotor blades elements are described in WO 2010/121927.

For the current invention, the color of the foil top layer (TL) is normally enclosed in the grey scale, preferably RAL 7038, RAL 9018, RAL 7035, RAL 2035, the signalization stripes should be enclosed to the red scale, more preferably RAL 3020. The white color within the signalization stripe required in some places is generally the RAL 9010.

The mono- or multilayer foil can be easily repaired. Repairing and preparation of coatings consists currently of trimming, sandpapering different coatings, such as the so called “in mould gel coat”, pore filler, filling pastes for greats faults, and top coating. Thermoplastic foils allow for thermo-welding, ironing, adding material by means of a hot melt pistol, or easy removal of material by scrapping it out by means of a blade, which can be hot or cold. Foils from different parts, e.g., pressure side and suction side, can be bound together by means of any of the methods mentioned above. Applying hot air and pressing foils against each other, adding hot melt or solvent to the interface can be used for attaching overlapping foils. The fixation of the foil to the mould can be done by placing the foil onto the mould surface, or by applying vacuum in the region between the mould and the foil in order to deep draw or simply fix it onto the mould avoiding wrinkles.

Thermoplastic polyurethanes (TPU) belong to the class of thermoplastic: elastomers (TPE). Similar to all TPEs, their physical crosslinking allows elastomeric behavior but they still be processed like thermoplastics. Preferred thermoplastic polyurethanes used according to the invention for top layer (TL) are made from aliphatic or aromatic thermoplastic polyurethanes (TPU), more preferable aliphatic TPU, which have improved resistance to yellowing. Preferred thermoplastic polyurethanes used according to the invention for bottom layer (BL) can be made from aliphatic or aromatic thermoplastic polyurethanes (TPU), the most preferable from aromatic thermoplastic polyurethanes (TPU).

Particular preferred thermoplastic polyurethanes may be obtained by reacting:

(a) at least one aliphatic, organic diisocyanate (a1) and/or aromatic organic diisocyanate (a2),

(b) at least one relatively high-molar-mass compound having hydrogen atoms reactive toward isocyanate,

(c) at least one, low-molar-mass chain extenders,

(d) at least one catalyst, and if desired

(e) one or more further conventional additives.

The component (a1) used comprises at least one aliphatic, organic diisocyanate. Examples are ethylene diisocyanate, tetramethylene 1,4-diisocyanate, hexamethylene 1,6-diisocyanate (HDI, dodecane 1,12-diisocyanate, and mixtures thereof. Among these, particular preference is given, as component (a1), to hexamethylene diisocyanate (HDI) or a mixture composed of at least 80% by weight of hexamethylene diisocyanate and up to 20% by weight of further aliphatic, organic diisocyanates. The term aliphatic diisocyanates also includes cycloaliphatic diisocyanates, such as isophorone diisocyanate (IPDI), cyclohexane 1,4-diisocyanate, 1-methylcyclohexane 2,4-diisocyanate, 1-methylcyclohexane 2,6-diisocyanate, and also their isomer mixtures, dicyclohexylmethane 4,4′0diisocyanate (H12MDI), dicyclohexylmethane 2,4′-diisocyanate, and dicyclohexylmethane 2,2′-diisocyanate, and also the corresponding isomer mixtures. The most preferable aliphatic isocyanates (a1) are hexamethylene diisocyanate (HDI) and dicyclohexylmethane 4,4′-diisocyanate (H12MDI) especially dicyclohexylmethane 4,4′-diisocyanate (H12MDI).

As a function of requirements placed upon the moldings to be produced from the TPUs, up to 25% by weight of the hexamethylene diisocyanate (HDI) can be replaced by one or more other aliphatic diisocyanates, such as isophorone diisocyanate, cyclohexane 1,4-diisocyanate, 1-methylcyclohexane 2,4-diisocyanate, 1-methylcyclohexane 2,6-diisocyanate, and isomer mixtures thereof, dicyclohexyl 4,4′-, 2,4′-, and 2,2′-diisocyanate, and isomer mixtures thereof.

In applications where requirements placed upon lighffastness are not very stringent, up to 20% by weight of the aliphatic diisocyanate can also be replaced by aromatic diisocyanates, such as tolylene 2,4-diisocyanate, tolylene 2,6-diisocyanate, or diphenylmethane 4,4′-, 2,2′-, or 2,4′-diisocyanate.

As isocyanate (a2), aromatic diisocyanates can be used. In particular the following aromatic isocyanates: 2,4-Toluen-diisocyanate, the mixture of 2,4- and 2,6-Toluen-diisocyanate, 4,4′-, 2,4′- and/or 2,2′-Diphenylmethane-diisocyanate, mixtures of 2,4′- and 4,4′-diphenylmethane-diisocyanate, urethane modified liquid 4,4′- and/or 2,4-diphenylmethane-diisocyanate, 4,4′-Diisocyanato-diphenylethane-(1,2) and 1,5-Naphthylene-diisocyanate. The most preferred is 4,4′-, 2,4′- and/or 2,2′-diphenylmethane-diisocyanate (MDI) as isocyanate (a).

The component (b) used can for example comprise polyester polyols (b1), polyether polyols (b2), polycarbonatediols (b3), or a mixture composed of polyether polyols and of polyester polyols, or a mixture composed of polyether polyols and of polycarbonatediols, or a mixture composed of polyester polyols and of polycarbonatediols. The weight-average molar mass of component B here is preferably from 600 to 5000 g/mol, particularly preferably from 700 to 4200 g/mol. The materials are preferably linear hydroxyl-terminated polyols, which can comprise small amounts of non-linear compounds as a result of the production process.

Suitable polyesterdiols (b1) can by way of example be prepared from dicarboxylic acids having from 2 to 12 carbon atoms, preferably from 4 to 6 carbon atoms, and from polyhydric alcohols. Examples of dicarboxylic acids that can be used are: aliphatic dicarboxylic acids, such as succinic acid, glutaric acid, adipic acid, suberic acid, azelaic acid, and sebacic acid, and aromatic dicarboxylic acids, such as phthalic acid, isophthalic acid, and terephthalic acid. The dicarboxylic acids can be used individually or in the form of a mixture, e.g., in the form of a succinic, glutaric, and adipic acid mixture. For preparation of the polyesterdiols it can, if appropriate, be advantageous to use, instead of the dicarboxylic acids, the corresponding dicarboxylic acid derivatives, such as carboxylic diesters having from 1 to 4 carbon atoms in the alcohol radical, carboxylic anhydrides, or carbonyl chlorides. Examples of polyhydric alcohols are glycols having from 2 to 10, preferably from 2 to 6, carbon atoms, e.g., ethylene glycol, diethylene glycol, 1,4-butanediol, 1,5-pentanediol, 1,6-hexanediol, 1,10-decanediol, 2,2-dimethyl-1,3-propanediol, 1,3-propanediol, and dipropylene glycol. As a function of the desired properties, the polyhydric alcohols can be used alone or, if appropriate, in a mixture with one another. Other suitable compounds are esters of carbonic acid with the diols mentioned, in particular with those having from 4 to 6 carbon atoms, e.g. 1,4-butanediol or 1,6-hexanediol, condensates of hydroxycarboxylic acids, such as hydroxycaproic acid, and polymerization products of lactones, for example of, if appropriate substituted, caprolactones. Polyesterdiols whose use is preferred are ethanediol polyadipates, 1,4-butanediol polyadipates, ethanediol 1,4-butanediol polyadipates, 1,6-hexanediol neopentyl glycol polyadipates, 1,6-hexanediol 1,4-butanediol polyadipates and polycaprolactones. The polyesterdiols have average molar masses of from 600 to 5000, preferably from 700 to 4200, and can be used individually or in the form of a mixture with one another. All molecular weight unities are given in g/mol.

Suitable polyetherdiols (b2) can be prepared by reacting one or more alkylene oxides having from 2 to 4 carbon atoms in the alkylene radical with a starter molecule which contains two active hydrogen atoms. Examples that may be mentioned of alkylene oxides are: ethylene oxide, propylene 1,2-oxide, epichlorhydrin, and butylene 1,2-oxide and butylene 2,3-oxide. It is preferable to use ethylene oxide, propylene oxide, and mixtures composed of propylene 1,2-oxide and ethylene oxide. The alkylene oxides can be used individually, in alternating succession, or in the form of a mixture. Examples of starter molecules that can be used are: water, aminoalcohols, e.g. N-alkyldiethanolamines, such as N-methyldiethanolamine, and diols, such as ethylene glycol, 1,3-propylene glycol, 1,4-butanediol, and 1,6-hexanediol.

It is also possible, if appropriate, to use a mixture of starter molecules. Other suitable polyetherdiols (b2) are the polymerization products of tetrahydrofuran, where these comprise hydroxy groups. It is also possible to use proportions of from 0 to 30% by weight, based on the bifunctional polyethers, of trifunctional polyethers, where the amount is, however, no more than that which produces a thermoplastically processable product. The substantially linear polyetherdiols have molar masses from 600 to 5000, preferably from 700 to 4200. They can be used individually or else in the form of a mixture with one another.

Particular preference is given to polymerization products of tetrahydrofuran where these comprise hydroxy groups, and to polyetherdiols based on ethylene oxide and/or propylene oxide.

The NCO index is preferably from 95 to 105 (this being calculated by taking the quotient of the ratios of equivalents of isocyanate groups and of the total number of hydroxy groups of component (b) and (c) and multiplying this number by 100).

As chain extenders (c), use is made of substances having a molecular weight of preferably less than 500 g/mol, particularly preferably from 60 to 400 g/mol, with chain extenders having 2 hydrogen atoms which are reactive toward isocyanates. These can preferably be used individually or in the form of mixtures. Preference is given to using diols having molecular weights of less than 400, particularly preferably from 60 to 300 and in particular from 60 to 150. Possible chain extenders are, for example, aliphatic, cycloaliphatic and/or araliphatic diols having from 2 to 14, preferably from 2 to 10, carbon atoms, e.g. ethylene glycol, 1,3-propanediol, 1,10-decanediol, 1,2-, 1,3-, 1,4-dihydroxyclohexane, diethylene glycol, dipropylene glycol and 1,4-butanediol, 1,6-hexanediol and bis(2-hydroxyethyl)hydroquinone, and low molecular weight hydroxyl-comprising polyalkylene oxides based on ethylene oxide and/or 1,2-propylene oxide and the abovementioned diols as starter molecules. Particular preference is given to using 1,4-butanediol, 1,3-propanediol, 1,6-hexanediol, ethylene glycol, or mixtures thereof as chain extenders (c).

The ratio by weight of the relatively high-molar-mass compound (b) having hydrogen atoms reactive toward isocyanates to chain extender (c) can be from 0.5:1 to 20:1, preferably from 1.5:1 to 13:1, and a higher proportion of chain extender here gives a hard product.

The chain extenders are used together with at least one aliphatic or aromatic, organic diisocyanate, as component (a), with at least one compound which is reactive toward component (a) and whose weight-average molar mass is from 500 to 10 000 g/mol, as component (b), and, if appropriate, with catalysts and conventional additives, as components (d) and (e).

The amount used, based on the polyol, of the chain extenders of component (c) is preferably from 5 to 130% by weight.

If a catalyst is used concomitantly, as component (d), its amount preferably used is from 1 to 1000 ppm, based on the thermoplastic polyurethane.

The amounts used of conventional additives of component (e) are preferably from 0 to 50% by weight, particularly preferably from 0 to 40% by weight, based on the entire thermoplastic polyurethane.

The thermoplastic polyurethanes of the invention can be prepared in the presence of at least one catalyst, as component (d).

Suitable catalysts are tertiary amines which are conventional and are known from the prior art, examples being triethylamine, dimethylcyclohexylamine, N-methylmorpholine, N,N′-dimethylpiperazine, 2-(dimethylaminoethoxy)ethanol, diazabicyclo-[2.2.2]octane and similar compounds, and also in particular organometallic compounds, such as titanic esters, iron compounds, tin compounds, e.g. stannous diacetate, stannous dioctoate, stannous dilaurate, or the dialkyltin salts of aliphatic carboxylic acids, e.g. dibutyltin diacetate, dibutyltin dilaurate, or similar compounds. Preferred catalysts are organometallic compounds, in particular titanic esters, iron compounds or tin compounds. Dibutyltin dilaurate is very particularly preferred.

According to one embodiment of the invention, the thermoplastic polyurethane of the invention has a hard phase fraction of >0.20, where the hard phase fraction is defined by the following formula:

$$Hard phase fraction = \{ {\sum }_{x = 1}^{k} [ ( {m}_{CEx} / {M}_{CEx} ) * {M}_{iso} + {m}_{KVx} ] \} / {m}_{tot}$$

where:

M_{CEx}: molar mass of chain extender x in g/mol

m_{CEx}: mass of chain extender x in g

Mᵢₛₒ: molar mass of isocyanate used in g/mol

mₜₒₜ: total mass of all starting materials in g

k: number of chain extenders.

In preferred embodiments, conventional auxiliaries (e) are also added, alongside catalysts (d), to the structural components (a) to (c). Mention may be made by way of example of surface-active substances, flame retardants, nucleating agents, oxidation stabilizers, lubricants and mold-release agents, dyes and pigments, other stabilizers, e.g. with respect to hydrolysis, light, heat, or discoloration, inorganic and/or organic fillers, reinforcing agents, and plasticizers.

Hydrolysis stabilizers used are preferably oligomeric and/or polymeric aliphatic or aromatic carbodiimides. For stabilization of a polyurethane with respect to aging it is preferable to add stabilizers to the polyurethane. For the purposes of the present invention, stabilizers are additives which protect a plastic or a plastics mixture from detrimental environmental effects. Examples are primary and secondary antioxidants, “hindered amine light stabilizers”, UV absorbers, hydrolysis stabilizers, quenchers, and flame retardants. Examples of commercially available hydrolysis stabilizers and other stabilizers can be found by way of example in the Plastics Additives Handbook, 5th edition, H. Zweifel, ed., Hanser Publishers, Munich, 2001 ([1]), pp. 98-136.

If the TPU used in the invention is exposed to thermooxidative degradation during its use, antioxidants can be added. It is preferable to use phenolic antioxidants. Examples of phenolic antioxidants are given in Plastics Additives Handbook, 5th edition, H. Zweifel, ed., Hanser Publishers, Munich, 2001, pp. 98-107 and 116-121. Preference is given to phenolic antioxidants with molar mass greater than 700 g/mol. An example of a phenolic antioxidant preferably used is pentaerythrityl tetrakis(3-(3,5-bis(1,1-dimethylethyl)-4-hydroxyphenyl)propionate) (Irganox® 1010). The concentrations at which the phenolic antioxidants are generally used are from 0.1 to 5% by weight, preferably from 0.1 to 2% by weight, in particular from 0.5 to 1.5% by weight, based in each case on the total weight of the TPU. The TPUs are preferably additionally stabilized by a UV absorber. UV absorbers are molecules which absorb high-energy UV light and dissipate the energy. Familiar UV absorbers used in industry are by way of example within the following groups: the cinnamic esters, the diphenylcyanoacrylates, the formamidines, the benzylidenemalonates, the diarylbutadienes, triazines, and also the benzotriazoles. Examples of commercially available UV absorbers are found in Plastics Additives Handbook, 5th edition, H. Zweifel, ed., Hanser Publishers, Munich, 2001, pp. 116-122. In a preferred embodiment the number-average molar mass of the UV absorbers is greater than 300 g/mol, in particular greater than 390 g/mol. It is moreover preferable that the molar mass of the UV absorbers used is not greater than 5000 g/mol, particularly not greater than 2000 g/mol. The benzotriazoles group is particularly suitable as UV absorber. Examples of particularly suitable benzotriazoles are Tinuvin® 213, Tinuvin® 328, Tinuvin® 571, and also Tinuvin® 384, and Eversorb®82. Preferred quantities added of the UV absorbers are from 0.01 to 5% by weight, based on the total mass of TPU, particularly preferably from 0.1 to 2.0% by weight, in particular from 0.2 to 0.5% by weight, based in each case on the total weight of the TPU. A UV stabilization system described above, based on an antioxidant and on a UV absorber, is often not sufficient to ensure good stability of the TPU of the invention in relation to the detrimental effect of UV radiation. In this case it is preferable that, in addition to the antioxidant and the UV absorber, a hindered amine light stabilizer (HALS) is also added to component (e) of the TPU of the invention. The activity of the HALS compounds is based on their ability to form nitroxyl radicals which intervene in the mechanism of oxidation of polymers. HALS are highly efficient UV stabilizers for most polymers. HALS compounds are well known and are available commercially. Examples of commercially available HALS stabilizers are found in Plastics Additives Handbook, 5th edition, H. Zweifel, Hanser Publishers, Munich, 2001, pp. 123-136. Hindered amine light stabilizers selected are preferably hindered amine light stabilizers where the number-average molar mass is greater than 500 g/mol. The molar mass of the preferred HALS compounds should moreover preferably not be greater than 10 000 g/mol, particularly not greater than 5000 g/mol. Particularly preferred hindered amine light stabilizers are bis(1,2,2,6,6-pentamethylpiperidyl) sebacate (Tinuvin® 765, Ciba Spezialitätenchemie AG) and the condensate of 1-hydroxyethyl-2,2,6,6-tetramethyl-4-hydroxypiperidine and succinic acid (Tinuvin® 622). Preference is in particular given to the condensate of 1-hydroxyethyl-2-2,6,6-tetramethyl-4-hydroxypiperidine and succinic acid (Tinuvin® 622) when the titanium content of the product is <150 ppm, preferably <50 ppm, particularly preferably <10 ppm. It is preferable to use HALS compounds ata concentration of from 0.01 to 5% by weight, particularly from 0.1 to 1% by weight, in particular from 0.15 to 0.3% by weight, based in each case on the total weight of the TPU. A particularly preferred UV stabilization system comprises a mixture of a phenolic stabilizer, a benzotriazole, and a HALS compound in the preferred quantities described above.

Plasticizers that can be used are any of the plasticizers known for use in TPUs. These comprise by way of example compounds comprising at least one phenolic group. Compounds of this type are described in EP 1 529 814 A2. It is moreover also possible, for example, to use polyesters with a molar mass of about 500 to 1500 g/mol based on dicarboxylic acids, benzoic acid, and at least one di- or triol, preferably a diol. It is preferable to use succinic acid, glutaric acid, adipic acid, suberic acid, azelaic acid, decandicarboxylic acid, maleic acid, fumaric acid, phthalic acid, isophthalic acid, and/or terephthalic acid as diacid component, and ethane-1,2-diol, diethylene glycol, propane-1,2-diol, propane-1,3-diol, dipropylene glycol, butane-1,4-diol, pentane-1,5-diol, and/or hexane-1,6-diol as diol. The ratio of dicarboxylic acid to benzoic acid here is preferably from 1:10 to 10:1. Plasticizers of this type are described in more detail by way of example in EP 1 556 433 A1.

Further details concerning the abovementioned auxiliaries and additional substances can be found in the technical literature, e.g. in Plastics Additives Handbook, 5th edition, H. Zweifel, ed., Hanser Publishers, Munich, 2001.

The preferred aliphatic thermoplastic polyurethanes are produced by reacting the stated components (a), (b), (c), and, if appropriate, (d) and (e) with one another, with mixing. The production process here can take place continuously or batchwise.

In the case of a continuous production process, it is preferable that components (b) and (c) are mixed continuously and then mixed intensively with the diisocyanate of component (a) (one-shot process). The reaction can then be completed in a discharge vessel, such as an extruder. The product obtained can, if appropriate, be pelletized.

The TPU is preferably produced continuously, and in particular here the polyol and the chain extender are mixed continuously, for example via a static mixer, this mixture being mixed with the diisocyanate, preferably HDI, for example in a static mixer, and reacted.

Additives can be added after the polymerization reaction via compounding or else during the polymerization reaction. By way of example, antioxidants and UV stabilizers can be dissolved in the polyol during the polymerization reaction. However, if an extruder is used, it is also possible by way of example to add lubricants and stabilizers in the second portion of the screw.

Suitable thermoplastic polyurethanes (TPU) are commercially available under the brand name Eliastollan®.

In the case of multilayer foils, preferred thermoplastic polyurethanes used according to the invention for top layer (TL) are made from aliphatic thermoplastic polyurethanes (TPU), comprising as component (a) aliphatic organic diisocyanate (a1) and as component (b) polyester polyols (b1), or polyether polyols (b2), or polycarbonatediols (b3), or mixtures thereof. Most preferable as component (b) polyether polyols (b2) are used. Preferred thermoplastic polyurethanes used according to the invention for bottom layer (BL) are made from aromatic thermoplastic polyurethanes (TPU), comprising as component (a) aromatic organic diisocyanate (a2) and as component (b) polyester polyols (bl), or polyether polyols (b2), or polycarbonatediols (b3), or mixtures thereof, most preferably polyether polyols (b2).

As electrically heatable monolayer, or bottom layer (BL) in multilayer foils, an electrically conductive polymer can be used, such as electrically conductive TPU filled with conductive additives (e) such as carbon nanotubes, carbon black, graphene, graphite or mixtures thereof, or as heatable elements of the bottom layer may be used a carbon mesh, conductive sheet or tape, a copper mesh, a metal mesh in general, or an imprinted pattern using an electrically conductive ink. The most preferable bottom layer (BL) is the electrically conductive TPU comprising most preferable as component (a) aromatic organic diisocyanate (a2) and as component (b) polyether polyols (b2), and as component (e) electrically conductive additive such as carbon nanotubes, or graphene, or graphite, or carbon black, or mixtures thereof.

Electrically conductive TPU used for bottom layer (BL) can be obtained using different conductive additives like carbon black, carbon fibers, graphite, graphene, carbon nanotubes (U.S. Pat. No. 4,265,789, EP0129193, WO 2008/017399, WO2010/020367). The most preferable are carbon nanotubes and carbon black. Examples are commercially available products like Nanocyl® 7000 (Nanocyl SA, Belgium), or Ketjenblack® EC-600JD (AkzoNobel) or Printex® XE2-B (Orion Engineered Carbons).

The most preferred heatable thermoplastic polyurethanes are conductive thermoplastic polyurethanes comprising carbon nanotubes as disclosed in WO 2005/82988 and DE 10 2012 203 994 A1.

The TPUs used in the invention for bottom layer comprise at least one conductivity additive (e) that is at least 90% carbon-based. A suitable conductivity additive (e) that is at least 90% carbon-based is in principle any of the conductivity additives known to the person skilled in the art that are at least 90% carbon-based. It is preferable that the conductivity additive (e) that is at least 90% carbon-based is selected in the invention from the group consisting of carbon nanotubes, graphene, and conductive carbon black, and mixtures thereof. It is preferable to use carbon nanotubes, carbon black or graphene, particularly carbon nanotubes.

In another embodiment, the present invention also provides the use of a composition as described above where the conductivity additive (e) that is at least 90% carbon-based is selected from the group consisting of carbon nanotubes, graphene, and conductive carbon black, and mixtures thereof.

In the invention, the conductivity additive (e) has maximum fineness of dispersion in the composition. It is possible in the invention to vary the quantity of this conductivity additive used. The quantity used of the additive is preferably from 0.1 to 30% by weight, based on the total weight of the mixture. The preferred quantity used can vary with the nature of the conductivity additive (e).

In another embodiment, the present invention also provides the use of a composition as described above where carbon nanotubes are used as the conductivity'additive (e) that is at least 90% carbon-based.

In so far as carbon nanotubes are used as conductivity additive, these preferably have maximum fineness of dispersion. The expression carbon nanotubes or CNT according to the prior art primarily means cylindrical carbon tubes of diameter from 3 to 100 nm and of length that is many times the diameter. These tubes are composed of one or more layers of organized carbon atoms and have a core that differs in morphology. Other terms used for these carbon nanotubes are by way of example “carbon fibrils” and “hollow carbon fibers”.

Carbon nanotubes have been known for a long time in the technical literature. Usual structures of these carbon nanotubes are of cylinder type. Among the cylindrical structures a distinction is made between single-wall carbon nanotubes and multiwall carbon nanotubes. Processes commonly used to produce these are by way of example arc discharge, laser ablation, chemical vapor deposition (CVD), and catalytic chemical vapor deposition (CCVD).

Another process known per se is the formation of carbon tubes in the arc discharge process where the resultant carbon nanotubes are composed of two or more graphite layers, and have been rolled up to give a seamless continuous cylinder, and nested into one another. Possibilities here, dependent on the roll vector, are chiral and achiral arrangements of the carbon atoms in relation to the longitudinal axis of the carbon fiber. Possible structures here forming the basis for the nanotubes involve a single coherent graphite layer (“scroll type”) or discontinuous graphite layers (“onion type”).

All of the carbon nanotubes for the purposes of the invention are single-wall or multiwall carbon nanotubes of cylinder type, scroll type, or with onion-type structure. Preference is given to use of multiwall carbon nanotubes of cylinder type, or scroll type, or a mixture of these.

Particular preference is given to use of carbon nanotubes with a ratio of length to external diameter that is greater than 5, preferably greater than 10.

The carbon nanotubes to be used, which can take the form of agglomerates, preferably have an average exterior diameter in the non-agglomerated form of from 1 to 50 nm, with preference from 2 to 30 nm, with particular preference from 3 to 20 nm, and in particular from 4 to 15 nm.

Alongside the scroll-type carbon nanotubes with only one continuous or discontinuous graphite layer, there are also carbon nanotube structures composed of a plurality of graphite layers taking the form of a rolled-up stack (multiscroll type). The relationship between this carbon nanotube structure and the simple scroll-type carbon nanotubes is comparable to that between the structure of multiwall cylindrical monocarbon nanotubes (cylindrical SWNTs) and the structure of the single-wall cylindrical carbon nanotubes (cylindrical SWNTs).

Suitable processes for the production of carbon nanotubes are in principle known from the prior art. A particularly preferred process for the production of carbon nanotubes is disclosed in WO 2006/050903 A2, EP 1401763, EP 1594802, EP 1827680, and WO 2007/0033438.

It is particularly preferable to use multiwall carbon nanotubes. A preferred example of these multiwall carbon nanotubes is Nanocyl® 7000 from Nanocyl SA, Belgium.

The content of carbon nanotubes in the composition used in the invention is preferably in the range from 0.1 to 20% by weight, more preferably from 0.5 to 15% by weight, still more preferably from 1 to 10% by weight, particularly preferably from 1 to 7% by weight, and in particular from 2 to 7% by weight, based on the total weight of the composition. TPU used in the invention for bottom layer is produced here in a kneader or twin-screw extruder from a thermoplastic polyurethane and from the conductivity additive, preferably carbon nanotubes.

The TPU used in the invention for bottom layer moreover has a volume resistivity, determined in accordance with ISO 3915, in the range from less than 1×100 ohm×cm and more than 0.001 ohm×cm. It is preferable that the volume resistivity, determined in accordance with ISO 3915, is in the range from 0.01 to 100 ohm×cm, preferably in the range from 0.05 to 50 ohm×cm, particularly in the range from 0.05 to 10 ohm×cm, very particularly in the range from 0.1 to 5 ohm×cm.

Conductive inks comprise conductive liquids or pastes which can be applied onto the surface of the top layer foil (TL), being sandwiched directly in between the foil and the composite part or on the top of a bottom layer transparent foil, which will be further post-coated with a liquid top coating for the case of a transparent mono-layer foil. This procedure can be done by any means, such as e.g., printing, silk screening, mask application, coat transfer, etc. This conductive ink should achieve a minimum adhesion threshold to the foil, which should be high enough to avoid desorption or detaching prior to blade manufacturing, but also resistant enough to withstand the environmental effects while keeping its conductivity to the desired levels. For that purpose, the matrix of the conductive ink when mixed to the conductive elements should show strong chemical or physical interactions with the surface of the foil. Electrical conductivity is achieved by mixing, or dispersing a conductive element into the matrix of the ink. Dispersion agents or solvents might be necessary. Examples of conductive elements are: carbon nanotubes (CNTs), carbon black, metal powders, graphite, grapheme, conductive polymers, etc. The conductivity levels necessary should correspond to the co-extruded foils, for a given electrode geometry, thickness, applied voltage, so that the wished power per area necessary to keep the surface ice free can be achieved as described below (0.5 kW/m2 up to 20 kW/m2 and the preferred ranges).

Conductive sheets can also be used as the heatable electrically conductive bottom layer. Again, conductivity is achieved by having conductive elements into the matrix of the sheet, or the sheet itself can be made of conductive conductive elements, such as a CNT foil. Also here, the necessary power per unity of area necessary to keep the surface of the blade ice free should be achieved.

The bottom layer may be integrated into multilayer foil by various methods, such as co-extrusion of the top layer (TL) together with the bottom layer (BL) containing the heating elements, or in case of conductive inks by imprinting the heating elements directly onto the top or bottom layer or by bringing the heating elements directly onto one side of the thermoplastic polyurethane surface foil.

The electrically conductive heatable part is heated up by the electric losses during passing electric current through it (“Joule-Effect”). The voltage applied to the heatable part is preferably in the range from 60 V to 1500 V, more preferably from 400 V to 800 V, even more preferably from 650 V to 750 V.

The mono- or multilayer foil can be placed covering the full area of the blade, but also strategic parts of it. It is preferably placed onto the leading edge of the blade, even more preferably covering ⅓ to ⅔ of the length of the leading edge of the blade, measured from the tip to the root section. The width of the bottom layer is preferably in the range from 0.05 m to 5 m, more preferably 0.1 to 2 m, even more preferably from 0.3 m to 1 m.

The monolayer foil may be transparent in order to allow for inspection of the infusion process. In this case the foil should be transparent and post-coated with an appropriate top-coating system, fulfilling the colors mentioned above.

The heating power per unit surface generated should be enough to remove ice or avoid its formation. It is generally in the range from 0.5 kW/m² up to 20 kW/m², preferably 1 kW/m² up to 10 kW/m², even more preferably in the range 3 kW/m² to 6 kW/m². Considering the resistivity of the heating element chosen, sizes, thickness, length, the design of the heating element should be chosen so, that it matches the areolar heating power required by applying the voltages mentioned above.

The contacting of the bottom layer can be done by various methods, such as copper cables, copper tapes (applied or evaporated onto the heating elements), or any other metal substituting copper, such as aluminum, carbon meshes electrically coupled with the bottom layer.

Electric current should be preferably applied to the bottom layer by using the cabling of the lightening protection system, in order to avoid burning out the heating elements in case lightening occurs. In this way, the preferable path for lightening down to Earth will be the low resistivity copper cable of the lightening protection system instead of the higher resistivity bottom layer.

The rotor blade element is generally produced by composite processing. Preferably, resin infusion is used as process. A preferred process for producing the rotor blade element according to the invention comprises the steps:

I) introducing a heatable thermoplastic foil onto a mold;

II) introducing the reinforcing materials and prefabricated elements and/or additional parts onto the mold;

III) vacuum-bagging of the complete setup

IV) infusing curable resin into the reinforcing materials and/or additional parts and,

V) curing the resin.

The heatable thermoplastic foil used in step I) is a mono- or multilayer foil as described above.

Preferably a foil comprising a protective top-layer made of thermoplastic polyurethane and a bottom layer which is electrically heatable layer.

The heatable foil in step I) is preferably a thermoplastic elastomer. In another preferred version, the heatable foil used in step I) is a multilayer foil comprising a protective top-layer made of thermoplastic polyurethane produced using aliphatic diisocyanate (a1) and a bottom layer (BL) comprising electrically heatable TPU or heatable electric conductive elements.

The reinforcing material used in step II) is preferably a reinforcing fiber, fabric or textile as well as foams as core materials, pre-fabricated parts or even pultruded parts. Preferably, the reinforcing fibers are glass fibers. The reinforcing material is preferably applied directly onto the heatable thermoplastic polyurethane foil. No additional adhesive layer is necessary.

After step II) the mold is closed and vacuum is applied by using a vacuum bag system. Preferably at least part of the heatable thermoplastic polyurethane foil is used as vacuum bag. The vacuum bag preferably has a strain at break of more than 500%. Vacuum-bagging of the complete setup and evacuation is done to generate a pressure difference to atmospheric pressure

In step IV) a curable resin, such as epoxy resin system, polyester resin or polyurethane resin, is used for infusion of the core setup. Preferably an epoxy resin system is used. Alternatively polymerizable thermoplastic systems, such as ring opening lactam polymerization to polyamide may be used. The infusion process can be vacuum assisted resin transfer molding (VARTM) using infusion mesh, peel ply and distribution mesh. Other liquid molding and composites processing techniques may also be combined with the disclosed foil approach.

If an imprinted pattern is applied to the bottom layer of the heatable thermoplastic polyurethane foil, this pattern can take the function of a flow-mesh, with infusion channels of the dimensions of current flow meshes, i.e., more preferable having channels with radial dimensions from 10 μm to 2 mm, even more preferable from 100 μm up to 1 mm, resulting in a “porosity” (φ) similar to that of current infusion meshes.

By curing the resin in step V) the heatable thermoplastic foil forms an integral surface of the rotor blade element. Since the heatable thermoplastic foil also functions as release foil from the mold, a separate release foil is not necessary.

The invention also relates to different configurations of the heatable foil and combinations with other materials: (a) direct combination with additional functional polymeric layers such as protective top-layers, particularly prepared via co-extrusion (b) post-coating with other layer, particularly top-coatings and putties (c) integrating function of the top coating to fulfill required performance (color, UV protection, erosion resistance, etc), (d) transparent setups containing non-densely packed heating elements (transparency is often required in order to enable optical analysis for quality control of the infused composite part).

In all cases the heating elements should be able to heat up the surface of the foil or top coating by any means, such as e.g., due to thermal losses during passing electric current through it. Heating elements can be such as carbon fibers, a surface printed conductive ink mesh (both, top and bottom surface), metal wires, etc. The heatable foil is preferably made of a thermoplastic polyurethane matrix (TPU). In case of using multi-layered setups, the top layer is preferably made of thermoplastic polyurethane, even more preferably aliphatic thermoplastic polyurethane, due to UV stability. In addition to foils with heating functions, multi-layer, multi-functional foils without the heating layer are comprised by this invention.

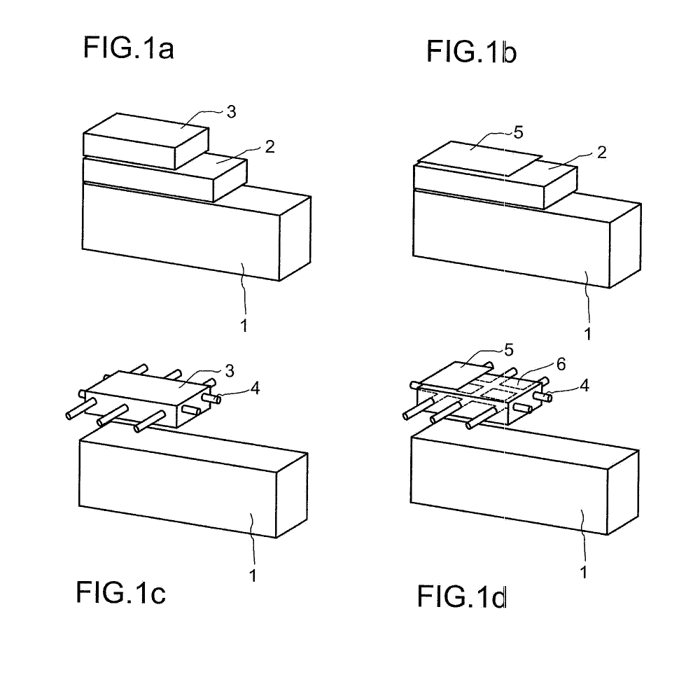

FIG. 1a to 1d ilustrates some of the configurations including different possibilities:

1a) heatable foils having heatable TPU as the heatable layer in the bottom layer (BL), represented by “2”, which was coextruded with the top layer (TL) represented by “3”;

1b) a mono-layer heatable TPU foil represented by “2”, which was top-coated with a suitable liquid coating system represented by “5”;

1c) a mono-layer non transparent TPU foil (“3”) having top coating similar properties (UV stability, erosion stability, etc), containing heating elements in it represented by “4” (as carbon meshes, metal wires, etc). The heating elements “4” could be also, as mentioned before, directly printed on the foil “3” staying in direct contact with the composite part “1”. 1d) a transparent mono-layer foil (“6”) and, having inner heating elements or printed heating elements “4”, which is post-coated by a suitable liquid top coating system “5”.

Furthermore, these foil configurations include multi-functions of importance for the blade manufacturing as well as their operation properties. By multi-functions one can mention: anti-erosion stability of the specifically mentioned TPU types in the specific configurations and thicknesses; UV resistance; top coating color standards; surface roughness & gloss standards suitable for rotor blades; improve in the production process by decreasing the number of steps, materials and costs on rotor blade manufacture, among others.

### First Embodiment

### Generation of an Anti/De-Icing Surface

An active anti or de-icing system is achieved by producing a blade containing a heatable top surface, which is able to melt or avoid ice formation or accretion on the surface.

A foil is produced by extruding TPU containing electrically conductive additives. The rotor blade element may be produced as described in WO 2010/121927 A2 using the heatable foil according to the invention as integrated foil. The main functionalities of such a foil are its anti or de-icing abilities, originated from its heating function, but also due to its hydrophobicity, which decreases considerably the binding energy of ice to the surface and therefore leads to an easier ice removal. The foil is not transparent due to the addition of conductive additives, which in general are of black color.

### Second Embodiment

### Generation of a Semi-Transparent Anti/De-Icing Surface

During the manufacturing of blades by infusion process, it is highly wished that the infused parts are well wetted by the resin, which can be epoxy, polyester, polyurethane, polyamide, etc. The quality proof is currently often visually, which turns impossible once the surface of the blade is coated with a non-transparent foil as described above. In order to solve that problem, on top of a transparent foil (i.e. made of TPU), an electrically conductive mesh is printed, maintaining the transparency of the foil. This printing process of an electrically conductive paint is done by “silk-screen like” printing using a template or by actually printing it by means of a printer machine. Alternatively, other printing techniques may be used As an alternative process to printing, electrically conductive elements are integrated by attaching metal wires, tapes or any electrical conductive elements to the foils. Finally, after the removal of the blade from the form and mounting the blade parts altogether, a top coating is preferably applied to this surface.

### Third Embodiment

### Generation of an “in Mould Top Coat” having Anti/De-Icing Properties

As in embodiment 2, where an electrically conductive mesh grid, able to heat the surface is printed, a foil having the needed top coat properties (e.g. anti-erosion, UV resistance, color standard) is equipped with the aforementioned conductive mesh. This conductive mesh is preferably between the composite and the foil. After demolding the blade, a coated surface with anti or de-icing properties is directly obtained, which saves surface treatment time & costs. In this example, transparency is not achieved, therefore this approach is particularly interesting for the pre-preg process (no need of infusion, the fibers are already wetted by a resin), or for processes employing quality control techniques beyond visual inspection. Examples of such analysis would be computer tomography, x-rays, RF waves, Echo techniques, any type of sound waves, surface waves (as Lamb waves), Rayleigh waves or any wave that interact with the dry regions, having wavelength in the range from 0.1 nm up to meters, or any optical test that could help to identify dry parts.

In a preferred version, the heatable surface is used for quality inspection. After heating up the surface after demolding, defects and non-impregnated areas can be detected by distinct temperature generation This solution can also be used to support other quality control techniques.

### Fourth Embodiment

### Generation of an “in Mould Top Coat” having Anti/De-Icing Properties (Bi-Layer)

Similar to the third embodiment, top coat foils and heating functions are combined by two distinct foils. The multilayer foil contains minimum two-layers, the top coat foil attached to an electrically heatable foil. The adhesion between both foils is preferably promoted by, e.g. thermally welding both foils to each other (with the help of pressure or without it). In this case, the top coat is placed towards the mould, whereas the heatable part is attached to the resin, both chemically and physically.

### Fifth Embodiment

### Generation of an “in Mould Top Coat”

Similar to the fourth embodiment, an “in mould top coat” without active heating for anti or deicing properties could be produced. For that, the steps regarding the production of the electrically conductive parts should be skipped. For the case of TPU foils, extremely high anti-erosion properties can be achieved. Preferably, multi-layer foils comprising at least two layers are used, which allows to match the different requirements of the top layer and the bottom layer.

### Sixth Embodiment

### Repairing of an “in Mould Top Coat”

Repairing of the blade surfaces previously to top coating has been one of the core activities for generating a good quality blade surface on top of which a top coat is applied. This ensures the life time of the coating and therefore, of the blade as a whole. Using thermoplastic or partially cross-linked thermoplastic foils, such as TPU foils, allows for a “thermal surface-repairing”, i.e. the flow ability of such materials in the presence of heat, substitutes the need of sandpapering the surface since defects can be corrected by inducing material to flow from one region to another by applying heat combined with pressure. This procedure is called here “ironing”. The tool for such an ironing procedure is similar in function to common home iron used for ironing clothes. In order to remove excess material, a sort of cutting blade, similar to that of a shaving razor is applied (or even a wood shaver, or carrot peeler). Therrno-mechanical cutting can also be used. These procedures are applicable for the surface repairing but also during binding the shell parts together. The finishing of the adhesive lines for instance, is achieved by thermally welding the excess foils from 2 different parts to each other (let on purpose in excess). If required, a TPU or thermoplastic liquid coating is added to the surface for further repairing (again by ironing or thermo-welding).

### Seventh Embodiment

### Resin Curing by Using the Homogeneous Surface Heating Produced by Heatable Foils (or Surfaces)

Currently, blades are generally produced on composite moulds or forms having its own heating fields, which can be promoted by carbon fibers, metal wires or even hot water passing through integrated pipes. The heatable foil allows direct partial or complete curing of the resin (infused or pre-preg) by heating via the foil Homogeneity is significantly enhanced, the energy consumption is decreased considerably, since the heating foil is directly transferring its heat to the resin without the need of heating the entire body of the mould (which also has strong insulation properties due to the tooling epoxy resin combined with glass fibers). Apart from that, the mould costs are tremendously reduced, since no heating elements toned to be integrated to the mould. The thermal fatigue of the composite mould is also considerably decreased, because heating metal wires-resin interfaces are no longer existent.

### Eights Embodiment

### Generation of an “in Mould Top Coat” Enabled to Detect Icing Events

On the external part of the top coat foils, electrical wires are placed or even printed following the examples previously mentioned. Such “wires” are placed close to each other forming a sort of electrodes of a capacitor. The dielectric medium of such a capacitor can be air, water, ice, or a mixture of ice, water and dust. In any case, the presence of ice can clearly identified from the dielectric response, which in turn is completely different from that of water or air. Combined with existing anemometric detectors, it can precisely identify the presence of ice on different spot of the surface. This ability of icing detection could support the selective heating of iced regions on the blade surface, in case the heatable coating is able to show different heating fields throughout the blade surface.

Heatable thermoplastic polyurethane foils are thermoformable and show excellent adhesion to epoxy resin systems. Bubbles or pinhole formation during application is strongly reduced. They function as well as active and passive systems for preventing and reducing icing on rotor blades. Thermoplastic polyurethane (TPU) foils do not stick to the mold. Normally the manufacture of blades can be made by infusion process without the need of a separate release foil. The rotor blade according to the invention is erosion resistant and has good aerodynamic characteristics due to their high surface quality. Consequently a significant improvement in blade lifetime is achieved

The process for producing the rotor blade element according to the invention has several advantages. Tooling costs are decreased since no mixers for mixing two-component coating systems are needed. Since the top layer of the heatable thermoplastic polyurethane foil functions also as release foil, no release agents have to be applied onto the mold and to be removed after deforming the blade. This decreases production time, costs and possible adhesion faults of the top coating. No sandpapering is required and the blade surface is easy to repair.

1.-12. (canceled)

13. A rotor blade element with a heatable foil (2, 3, 6) comprising a thermoplastic elastomer (TPE) and electric conductive elements (4), wherein the heatable foil is a multilayer foil comprising at least two layers, a top layer (3) made of a thermoplastic elastomer and an electrically heatable bottom layer (2), comprising
(a) electric conductive elements (4) selected from carbon mesh, conductive sheet or tape, metal mesh or imprinted pattern of electrically conductive ink or
(b) is made of thermoplastic polyurethane (TPU) comprising graphite, metal particles, graphene, carbon nanotubes, carbon black or mixtures thereof.

14. A rotor blade element according to claim 13, wherein thermoplastic polyurethane (TPU) is used as thermoplastic elastomer.

15. The rotor blade element according to claim 13, wherein the heatable foil is a multilayer foil made by co-extrusion of the top layer together with the bottom layer.

16. The rotor blade element according to claim 13, wherein the electrically heatable bottom layer (2) is made from thermoplastic polyurethane comprising aromatic organic diisocyanate and polyetherpolyols.

17. The rotor blade element according to claim 14, wherein the top layer (3) consists of aliphatic thermoplastic polyurethane.

18. The rotor blade element according to claim 13, wherein the top layer (3) consists of aliphatic thermoplastic polyurethane comprising an aliphatic organic diisocyanate and a polyether polyol.

19. The rotor blade element according to claim 13, wherein the heatable foil (2, 3, 6) has a thickness in the range from 10 to 2000 μm.

20. The rotor blade element according to claim 13, wherein the heatable foil (2, 3, 6) is directly fixed onto the shell (1) of the rotor blade element structure.

21. A wind power plant comprising rotor blade elements according to claim 13.

22. A process for producing a rotor blade element according to claim 13 comprising the steps:
I) introducing a heatable foil (2, 3, 6), which is a multilayer foil comprising a protective layer made of thermoplastic polyurethane produced using aliphatic diisocyanate and a bottom layer comprising heatable electric conductive elements (4) onto a mold;
II) introducing a reinforcing material and prefabricated elements and/or additional parts onto the mold;
III) III) vacuum-bagging of the complete setup
IV) infusing curable resin; and
V) curing the resin.

23. The process according to claim 22, wherein fibers are used as reinforcing material.

24. The process according to claim 22, wherein an epoxy resin system is used as curable resin.
